(19) United States
(12) Patent Application Publication
(10) Pub. No.: US 2011/0208783 A1
(43) Pub. Date: Aug. 25, 2011

(54) Integration of User Identifiers

(75) Inventors: Mark C. Dolphin, Lincoln, RI (US); William B. Caemmerer, Brooklyn, NY (US); Lisa R. Handalian, Medford, MA (US); Rodney W. Bass, Princeton, NJ (US); Jeffrey D. Hindle, Warwick, RI (US); Shyamapad Hazra, Charlotte, NC (US); Susan M. Hartman, Lake Orion, MI (US); Joseph N. Paolantonio, Johnston, RI (US); Christopher T. Hart, Charlotte, NC (US); Bradley P. Vigrass, Newton, PA (US); Holly J. Warren, Landenberg, PA (US); Christine M. Watts, Charlotte, NC (US); Chris Purvis, Waxhaw, NC (US); Scott M. Blandford, Hopewell, NJ (US)

(73) Assignee: Bank of America Corporation, Charlotte, NC (US)

(21) Appl. No.: 12/709,737

(22) Filed: Feb. 22, 2010

(51) Int. Cl. G06F 17/30

(52) U.S. Cl. 707/800; 707/E17.011

(57) ABSTRACT

User identifiers associated with a plurality of enterprises may be integrated. A request is received to link a plurality of user identifiers associated with a plurality of enterprises. A first user identifier associated with a first enterprise is received, and a second user identifier associated with a second enterprise is received. The first user identifier and a first enterprise identifier are stored in a first data structure of a memory. The second user identifier and a second enterprise identifier are stored in a second data structure of the memory. A first account identifier associated with the first user identifier is determined by a processor. A second account identifier associated with the second user identifier is determined by the processor. The first user identifier, the second user identifier, the first account identifier, and the second account identifier are stored in a virtual profile to link the first and second user identifiers and facilitate retrieval of information associated with the first and the second user identifiers from a selected one of the first enterprise and the second enterprise.

### TECHNICAL FIELD OF THE INVENTION

This invention relates generally to integrating information and, more specifically, to the integration of user identifiers.

### BACKGROUND

Account information, services, and products may be offered through a number of enterprises using a variety of frameworks. In particular, a user may utilize financial services and products from different enterprises. The enterprises may use different frameworks to provide the products and services and to facilitate the provision of information to the user. Because these frameworks are different, the user interacts with each framework separately to access information.

### SUMMARY OF THE DISCLOSURE

In accordance with the present invention, disadvantages and problems associated with integrating user identifiers from disparate frameworks may be reduced or eliminated.

According to one embodiment of the present invention, user identifiers associated with a plurality of enterprises may be integrated. A request is received to link a plurality of user identifiers associated with a plurality of enterprises. A first user identifier associated with a first enterprise is received, and a second user identifier associated with a second enterprise is received. The first user identifier and a first enterprise identifier are stored in a first data structure of a memory. The second user identifier and a second enterprise identifier are stored in a second data structure of the memory. A first account identifier associated with the first user identifier is determined by a processor. A second account identifier associated with the second user identifier is determined by the processor. The first user identifier, the second user identifier, the first account identifier, and the second account identifier are stored in a virtual profile to link the first and second user identifiers and facilitate retrieval of information associated with the first and the second user identifiers from a selected one of the first enterprise and the second enterprise.

Certain embodiments of the invention may provide one or more technical advantages. A technical advantage of one embodiment allows a user to view information associated with different enterprises through a single framework. For example, a user may access a website associated with a particular enterprise and view the user's information associated with that particular enterprise along with the user's information associated with another enterprise. Another technical advantage of an embodiment allows the user to access information associated with multiple enterprises from the websites associated with each enterprise. Therefore, a user is allowed to use whichever website that meets the user's personal preference. Another technical advantage of an embodiment establishes a trusted relationship between various enterprises to allow a user to perform bank functions on accounts associated with different enterprises through a single framework.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates a system that integrates user identifiers from different enterprises;

FIG. 2 illustrates a particular embodiment of a federation module that facilitates the integration of user identifiers; and

FIG. 3 is a diagram that illustrates a linking sequence and a sequence to access information from different enterprises.

### DETAILED DESCRIPTION OF THE DRAWINGS

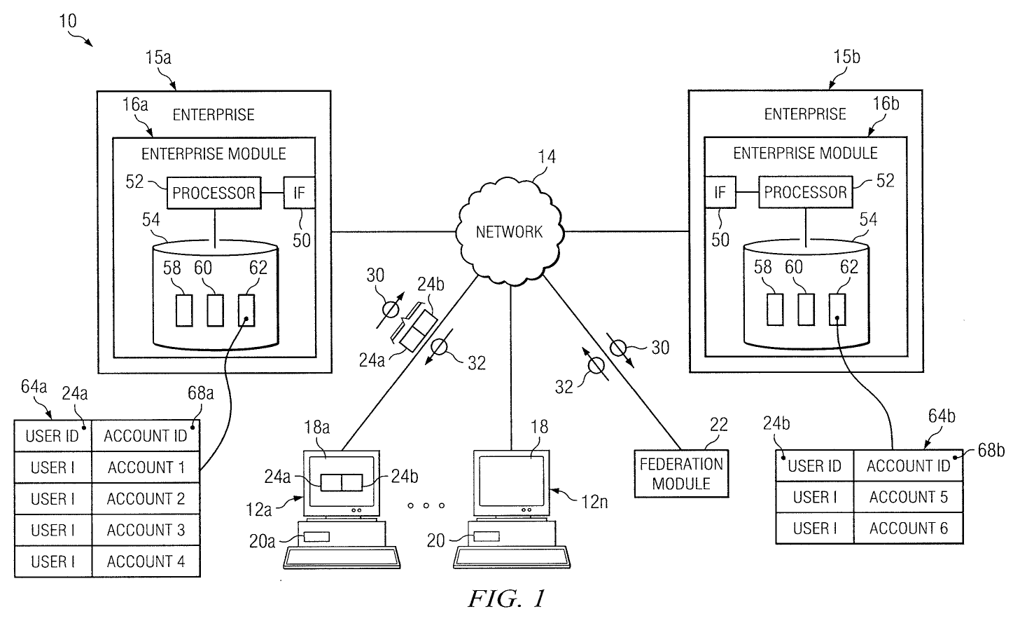

Embodiments of the present invention and its advantages are best understood by referring to FIGS. 1 through 3, like numerals being used for like and corresponding parts of the various drawings.

FIG. 1 illustrates a system 10 that integrates user identifiers from different enterprises 15. System 10 includes one or more computers 12 that communicate over one or more networks 14 to access information associated with enterprises 15. Computers 12 interact with enterprises 15, enterprise modules 16, and federation module 22.

A user of computer 12 may have several user identifiers 24 associated with different enterprises 15. For example, a user may have a first user identifier 24 associated with a first enterprise 15, and the user may have a second user identifier 24 associated with a second enterprise 15. With user identifier 24, each enterprise 15 allows the user to access information regarding the accounts and other products and services through a particular framework associated with the particular enterprise 15. Previously, the user would interact with enterprises 15 separately and could not view information associated with the different user identifiers 24 through a single framework. The teachings of the disclosure recognize that it would be desirable to allow the user to view information associated with different enterprises 15 through a single framework and to perform functions through the single framework. For example, the user may perform any suitable banking function using the single framework, such as transfer funds between the different accounts, close accounts, open accounts, pay bills, and/or withdraw money.

According to the illustrated embodiment, system 10 includes computers 12a-12n, where n represents any suitable number, that communicate with enterprises 15 through network 14. Computer 12 may include a personal computer, a laptop, a wireless or cellular telephone, a personal digital assistant, or any other device suitable for communicating in system 10. A user of computer 12 may access a user's information associated with each of enterprises 15a and 15b by interacting with either enterprise 15a or 15b. Once a user accesses information associated with enterprise 15a or 15b, the user may access any suitable account information, such as checking account information, savings account information, education savings information, credit card information, bill payment information, loan information, brokerage account information, investment account information, or any combination of the preceding. To access the account information, the user is directed to the particular enterprise 15 associated with the requested account information.

In the illustrated embodiment, computer 12 includes a graphical user interface (“GUI”) 18 that displays information received from enterprise 15a or 15b to the user. GUI 18 is generally operable to tailor and filter data entered by and presented to the user. GUI 18 may provide the user with an efficient and user-friendly presentation of information. For example, GUI 18 may display information regarding a checking account, a savings account, a brokerage account, a loan account, an investment account, or any other suitable information. GUI 18 may comprise a plurality of displays having interactive fields, pull-down lists, and buttons operated by the user. GUI 18 may include multiple levels of abstraction including groupings and boundaries. It should be understood that the term GUI 18 may be used in the singular or in the plural to describe one or more GUIs 18 and each of the displays of a particular GUI 18.

Computer 12 also includes a web browser 20. Web browser 20 represents an application that allows a user of computer 12 to interact with a website, hosted by enterprise 15 for example, by transmitting information to and receiving information from the website. As an example, web browser 20 may include Microsoft Internet Explorer®, Mozilla Firefox®, Apple Safari™, or Opera®. In an embodiment, computer 12 may access information on a website through web browser 20 using user identifier 24. User identifier 24 represents identifying information of a user that allows a user to access information from enterprise 15, and identifies a particular user's access privileges. A user may create user identifier 24 or enterprise 15 may assign the identifier to the user. User identifiers 24 associated with various enterprises 15 may be the same or different. In addition to using user identifier 24 to access information, the user may also utilize a password to access information. In an embodiment, a user has user identifiers 24 associated with different enterprises 15 and may link user identifiers 24 associated with the different enterprises 15. Once user identifiers 24 are linked, the user may enter user identifier 24 on a website to view information from enterprise 15 associated with the website and to view information from another enterprise 15.

Network 14 represents any suitable network operable to facilitate communication between the components of system 10, such as computers 12, enterprises 15, enterprise modules 16, and federation module 22. Network 14 may include any interconnecting system capable of transmitting audio, video, signals, data, messages, or any combination of the preceding. Network 14 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof operable to facilitate communication between the components.

Enterprises 15a and 15b may refer to a financial institution, such as a bank, brokerage house, or investment firm, that communicates with computers 12 to provide information regarding financial accounts, products, and services. Even though enterprise 15 is referred to as a financial institution, enterprise 15 represents any suitable type of entity in any suitable industry that allows a user to access information through a website. Each enterprise 15 uses a particular framework to retrieve information for a user, communicate information to the user, store information associated with the user, or perform any other suitable operation for financial accounts, products, or services. In an embodiment, the frameworks used by enterprises 15a and 15b are different and are not integrated. Enterprises 15a and 15b may include one or more enterprise modules 16a and 16b, respectively.

Enterprise modules 16a and 16b represent any suitable components that facilitate the operation of enterprise 15 by facilitating communication with computers 12 and providing information to computers 12 regarding user information, financial accounts, products, and services. Enterprise module 16 may include a network server, any suitable remote server, a mainframe, a host computer, a workstation, a web server, a personal computer, a file server, or any other suitable device operable to communicate with computers 12 and process data. In some embodiments, enterprise modules 16 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems. The functions of enterprise modules 16 may be performed by any suitable combination of one or more servers or other components at one or more locations. In the embodiment where the modules are servers, the servers may be public or private servers, and each server may be a virtual or physical server. The server may include one or more servers at the same or at remote locations. Also, enterprise module 16 may include any suitable component that functions as a server.

In the illustrated embodiment, enterprise module 16 includes a network interface 50, a processor 52, and a memory 54.

Network interface 50 represents any suitable device operable to receive information from network 14, transmit information through network 14, perform suitable processing of the information, communicate to other devices, or any combination of the preceding. For example, network interface 50 receives requests for information associated with user identifiers 24. As another example, network interface 50 communicates information regarding user identifiers 24 to federation module 22 to facilitate linking user identifier 24 to another user identifier 24. Network interface 50 represents any port or connection, real or virtual, including any suitable hardware and/or software, including protocol conversion and data processing capabilities, to communicate through a LAN, WAN, or other communication system that allows enterprise module 16 to exchange information with network 14, computers 12, other enterprises 15, federation module 22 or other components of system 10.

Processor 52 communicatively couples to network interface 50 and memory 54, and controls the operation and administration of enterprise module 16 by processing information received from network interface 50 and memory 54. Processor 52 includes any hardware and/or software that operates to control and process information. For example, processor 52 executes management software 58 to control the operation of enterprise module 16. Processor 52 may be a programmable logic device, a microcontroller, a microprocessor, any suitable processing device, or any suitable combination of the preceding.

Memory 54 stores, either permanently or temporarily, data, operational software, or other information for processor 52. Memory 54 includes any one or a combination of volatile or nonvolatile local or remote devices suitable for storing information. For example, memory 54 may include random access memory (RAM), read only memory (ROM), magnetic storage devices, optical storage devices, or any other suitable information storage device or a combination of these devices. While illustrated as including particular modules, memory 54 may include any suitable information for use in the operation of enterprise module 16.

In the illustrated embodiment, memory 54 includes management software 58, management data 60, and accounts data 62. Management software 58 represents any suitable set of instructions, logic, or code embodied in a computer-readable storage medium and operable to facilitate the operation of enterprise module 16. Management data 60 includes any suitable information regarding the management of enterprise 15. For example, management data 60 may include information regarding the management of the website associated with enterprise 15, rules regarding a user accessing account information, data regarding authentication, any other information regarding the management of enterprise 15, or any suitable combination of the preceding. Accounts data 62 represents any information regarding accounts handled by enterprise 15. For example, accounts data 62 may include account numbers, nicknames for accounts, account identifiers 68 associated with an account, balance information of an account, limits of an account, disclaimers associated with an account, customer preferences, any other suitable data, or any suitable combination of the preceding.

In an embodiment, a portion of accounts data 62 may be organized in a profile 64 that associates each account identifier 68 with a user identifier 24. For example, user 1 has account 1, account 2, account 3 and account 4 with enterprise 15a. Profile 64a associates user identifier 24a with each account identifier 68a. In the illustrated embodiment, user 1 associates with account 1, user 1 associates with account 2, user 1 associates with account 3, and user 1 associates with account 4. Similarly, user 1 has account 5 and account 6 with enterprise 15b. Profile 64b associates user identifier 24b with each account identifier 68b. In the illustrated embodiment, user 1 associates with account 5 and user 1 associates with account 6 in enterprise 15b.

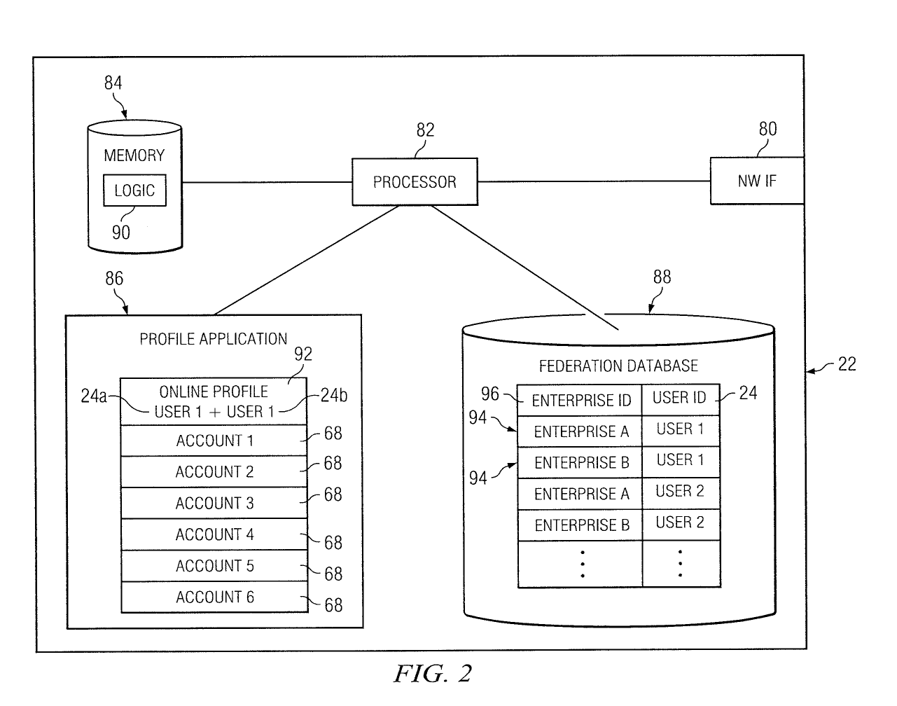

Federation module 22 represents any suitable component that facilitates linking user identifiers 24 of different enterprises 15. Federation module 22 may include a network server, any suitable remote server, a mainframe, a host computer, a workstation, a web server, a personal computer, a file server, or any other suitable device operable to communicate with computers 12, enterprises 15, and enterprise modules 16. In some embodiments, federation module 22 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems. The functions of federation module 22 may be performed by any suitable combination of one or more servers or other components at one or more locations. For example, each enterprise 15 may include a federation module 22 or federation module 22 may be a separate component. In the embodiment where the modules are servers, the servers may be public or private servers, and each server may be a virtual or physical server. The server may include one or more servers at the same or at remote locations. Also, federation module 22 may be any suitable component that functions as a server. Federation module 22 is discussed in greater detail in FIG. 2.

In an exemplary embodiment of operation, a user utilizes computer 12a to access a website associated with enterprise 15a using web browser 20a. The website appears on GUI 18a. The user enters data on the website to access information from enterprise 15a regarding financial accounts, services, and/or products associated with the user. The data entered on the website represents user identifier 24a associated with enterprise 15a.

In a particular embodiment, the website of enterprise 15a provides the user with an option to link user identifiers 24a and 24b associated with enterprises 15a and 15b, respectively. Accordingly, the user would be able to view information associated with user identifiers 24a and 24b through the website associated with either enterprise 15a or enterprise 15b. In the illustrated embodiment, the user determines to link user identifiers 24a and 246b and communicates a request 30 to federation module 22 to initiate and facilitate linking user identifiers 24a and 246b. Request 30 may include any suitable information, such as user identifier 24a associated with enterprise 15a and user identifier 24b associated with enterprise 15b.

Federation module 22 receives request 30 and begins the process to link user identifiers 24a and 24b. Federation module 22 creates a data structure that facilitates user interaction with either enterprise 15a or 15b to access information. In addition to the data structure, an online profile is created to associate user identifiers 24 and account identifiers 68. Federation module 22 communicates a confirmation 32 to computer 12 to confirm completion of the linking process. Confirmation 32 may appear on the website associated with enterprise 15a. Accordingly, the user is able to interact with the single framework to view information from different enterprises 15.

A component of system 10 may include an interface, logic, memory, and/or other suitable element. An interface receives input, sends output, processes the input and/or output, and/or performs other suitable operations. An interface may comprise hardware and/or software. Logic performs the operation of the component, for example, logic executes instructions to generate output from input. Logic may include hardware, software, and/or other logic. Logic may be encoded in one or more non-transitory, tangible media, such as a computer readable medium or any other suitable tangible medium, and may perform operations when executed by a computer. Certain logic, such as a processor, may manage the operation of a component. Examples of a processor include one or more computers, one or more microprocessors, one or more applications, and/or other logic.

Modifications, additions, or omissions may be made to system 10 without departing from the scope of the invention. For example, system 10 may implement authentication procedures to confirm that the information submitted in request 30 belongs to the same user and should be linked. As another example, a user may link user identifiers 24 associated with any number of enterprises 15 to create an N-way federation, where N represents any suitable whole number greater than two. According to this example, a user may link the following: user identifier 24a associated with enterprise 15a, user identifier 24b associated with enterprise 15b, and user identifier 24c associated with enterprise 15c. As yet another example, a single user identifier 24 from an enterprise 15 may be linked to a single user identifier 24 from another enterprise 15. Additionally, a single user identifier 24 from an enterprise 15 may be linked to several different user identifiers 24 from another enterprise 15. System 10 may include any number of computers 12, networks 14, enterprises 15, enterprise modules 16, and federation modules 22. Any suitable logic may perform the functions of system 10 and the components within system 10.

FIG. 2 illustrates a particular embodiment of federation module 22 that facilitates the integration of user identifiers 24.

Network interface 80 represents any suitable device operable to receive information from network 14, transmit information through network 14, perform suitable processing of the information, communicate to other devices or any combination of the preceding. For example, network interface 80 receives request 30 to link user identifiers 24a and 24b associated with enterprises 15a and 15b, respectively, from computer 12 through network 14. As another example, network interface 80 communicates information associated with the linked user identifiers 24 for display on computer 12. Network interface 80 represents any port or connection, real or virtual, including any suitable hardware and/or software, including protocol conversion and data processing capabilities, to communicate through a LAN, WAN, or other communication system that allows federation module 22 to exchange information with network 14, computers 12, enterprises 15, enterprise modules 16, or other components of system 10.

Processor 82 communicatively couples to network interface 80, memory 84, profile application 86, and federation database 88 and controls the operation and administration of federation module 22 by processing information received from network interface 80, memory 84, profile application 86, and federation database 88. Processor 82 includes any hardware and/or software that operates to control and process information. For example, processor 82 executes logic 90 to control the operation of federation module 22. Processor 82 may be a programmable logic device, a microcontroller, a microprocessor, any suitable processing device, or any suitable combination of the preceding.

Memory 84 stores, either permanently or temporarily, data, operational software, or other information for processor 82. Memory 84 includes any one or a combination of volatile or nonvolatile local or remote devices suitable for storing information. For example, memory 84 may include random access memory (RAM), read only memory (ROM), magnetic storage devices, optical storage devices, or any other suitable information storage device or a combination of these devices. While illustrated as including particular modules, memory 84 may include any suitable information for use in the operation of federation module 22. In the illustrated embodiment, memory 84 includes logic 90. Logic 90 represents any suitable set of instructions, software, or code embodied in a computer-readable storage medium and operable to facilitate the operation of federation module 22. For example, logic 90 may include rules to verify the association of user identifiers 24 with enterprises 15 before creating data structure 94 in federation database 88.

Profile application 86 represents an application that aggregates data from various sources and stores the data, either permanently or temporarily, in an organized manner. In the illustrated embodiment, profile application 86 stores the collected data in online profile 92. Online profile 92 includes user identifiers 24 associated with enterprises 15a and 15b that are linked and account identifiers 68 associated with the user identifiers 24. When a user requests information regarding the linked user identifiers 24, federation module 22 may access online profile 92 to provide the requested information. Because profile 92 includes user identifiers 24 for different enterprises 15 and includes account identifiers 68 associated with each user identifier 24, the user may go back and forth between the websites of the different enterprises 15 and may access any enterprise 15 to view information. Therefore, federation module 22 promotes bidirectionality between enterprises 15.

Federation database 88 represents a database that stores, either permanently or temporarily, the association of user identifier 24 with enterprise identifier 96. Enterprise identifier 96 represents any unique or non-unique identification that identifies enterprise 15. Federation database 88 comprises data structures 94 that store the association. Data structures 94 may include any suitable information that represents the association. For example, a single data structure 94 may include a single enterprise identifier 96 and a single user identifier 24. In the illustrated embodiment, “User 1” represents user identifier 24 of a user for enterprises 15a and 15b, “Enterprise A” represents enterprise identifier 96 for enterprise 15a, and “Enterprise B” represents enterprise identifier 96 for enterprise 15b. Federation database 88 stores the association between “User 1” and “Enterprise A” in data structure 94a and stores the association between “User 1” and “Enterprise B” in data structure 94b. As another example, data structure 94 may include an association between several enterprise identifiers 96 and a common user identifier 24. As yet another example, data structure 94 may include an association between several enterprise identifiers 94 and several associated user identifiers 24.

In the illustrated embodiment, federation module 22 binds one user identifier 24 to another user identifier 24. In other embodiments, federation module 22 may bind any suitable number of user identifiers 24 to any suitable number of other user identifiers 24. For example, federation module 22 may bind one user identifier 24 to multiple user identifiers 24. As another example, federation module 22 may bind multiple user identifiers 24 to multiple other user identifiers 24. As yet another example, federation module 22 may bind user identifiers from N enterprises 15.

Modifications, additions, or omissions may be made to federation module 22. For example, online profile 92 may also include a user preferences that represent how a user prefers to interact with each enterprise 15. Any suitable logic comprising software, hardware, other logic, or any suitable combination of the preceding may perform the functions of federation module 22.

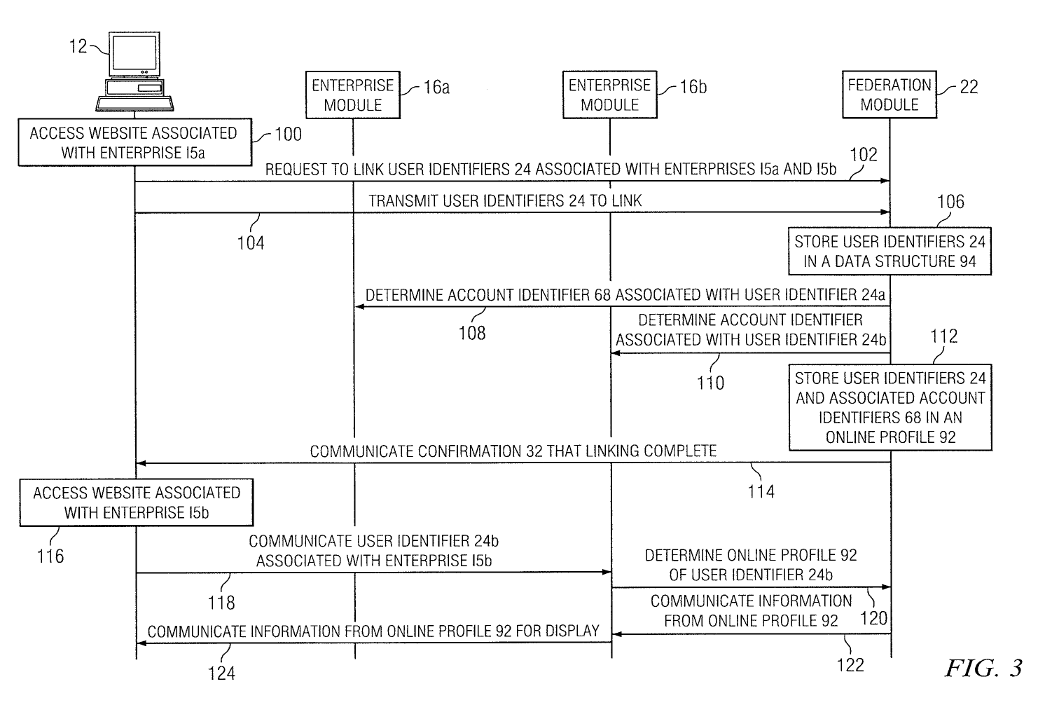

FIG. 3 is a diagram that illustrates a linking sequence and a sequence to access information from different enterprises 15.

At step 100, computer 12 accesses a website associated with enterprise 15a. The website may include information that allows a user to link user identifiers 24 associated with different enterprises 15. At step 102, computer 12 communicates a request 30 to link user identifiers 24a and 24b associated with enterprises 15a and 15b. In the illustrated embodiment, computer 12 communicates request 30 to federation module 22. At step 104, computer 12 communicates user identifiers 24a and 24b for federation module 22 to link. Federation module 22 stores user identifiers 24a and 24b in data structures 94 at instance 106. Data structures 94 also includes the associated enterprise identifiers 96.

Upon creating data structures 94 in federation database 88, federation module 22 facilitates the creation of online profile 92. Federation module 22 then determines account identifiers 68 associated with each user identifier 24. Federation module 22 may communicate with enterprise module 16 to determine the associated account identifiers 68. At step 108, federation module 22 communicates with enterprise module 16a to determine account identifiers 68 associated with user identifier 24a. Federation module 22 communicates with enterprise module 16b at step 110 to determine account identifier 68 associated with user identifier 24b. At instance 112, federation module 22 stores user identifiers 24 and associated account identifiers 68 in an online profile 92. Online profile 92 may be temporarily stored in application 86 and accessed to respond to a received request for information. Federation module 22 communicates confirmation 32 that the linking is complete at step 114 to computer 12.

A user of computer 12 may now access the website associated with either enterprise 15a or 15b to view information associated with each enterprise 15. At step 116 a user of computer 12 accesses the website associated with enterprise 15b. User identifier 24b is communicated at step 118 to enterprise module 16b. Enterprise module 16b determines that the user has linked user identifiers 24 associated with enterprises 15a and 15b. At step 120, enterprise module 16b determines online profile 92 associated with user identifier 24b. Federation module 22 communicates information from online profile 92 to enterprise module 16b at step 122. Enterprise module 16b then communicates the information from online profile 92 for display on computer 12 at step 112. When the user desires to access specific account information from either enterprise 15a or 15b, the user will be redirected to the website that hosts the particular account information. For example, when a user accesses the website associated with enterprise 15a and views information associated with both enterprises 15a and 15b, the user may further access specific account information associated with enterprise 15b. In this example, the user will be directed to the website associated with enterprise 15b to access the specific account information.

Modifications, additions, or omissions may be made to the flow diagram. For example, computer 12 may request to view information for enterprises 15a and 15b from either enterprise 15a or 15b. Additionally, steps in FIG. 3 may be performed in parallel or in any suitable order.

Certain embodiments of the invention may provide one or more technical advantages. A technical advantage of one embodiment allows a user to view information associated with different enterprises 15 through a single framework. For example, a user may access a website associated with a particular enterprise 15 and new user's information associated with that particular enterprise 15 along with the user's information associated with another enterprise 15. Another technical advantage of an embodiment allows the user to access information associated with multiple enterprises 15 from the websites associated with each enterprise 15. Therefore, a user is allowed to use whichever website that meets the user's personal preference. Another technical advantage of an embodiment establishes a trusted relationship between various enterprises 15 to allow a user to perform bank functions on accounts associated with different enterprises 15 through a single framework.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A method for linking user identifiers associated with a plurality of enterprises, comprising:
receiving a request to link a plurality of user identifiers associated with a plurality of enterprises;
receiving a first user identifier associated with a first enterprise;
receiving a second user identifier associated with a second enterprise;
storing, in a first data structure of a memory, the first user identifier and a first enterprise identifier;
storing, in a second data structure of the memory, the second user identifier and a second enterprise identifier;
determining, by a processor, a first account identifier associated with the first user identifier;
determining, by the processor, a second account identifier associated with the second user identifier; and
storing the first user identifier, the second user identifier, the first account identifier, and the second account identifier in a virtual profile to link the first and second user identifiers and facilitate retrieval of information associated with the first and the second user identifiers from a selected one of the first enterprise and the second enterprise.

2. The method of claim 1, further comprising creating a data structure to store a user identifier and an enterprise identifier, wherein the data structure represents an association between the user identifier and the enterprise identifier.

3. The method of claim 1, wherein the request comprises the first user identifier and the second user identifier.

4. The method of claim 1, further comprising creating the virtual profile by consolidating the first user identifier, the second user identifier, the first account identifier, and the second account identifier.

5. The method of claim 1, wherein:
a third user identifier is associated with the first enterprise and the second enterprise; and
the request comprises the third user identifier.

6. The method of claim 1, further comprising:
receiving a user identifier, wherein the user identifier is a selected one of the first user identifier and the second user identifier;
accessing the virtual profile to determine account identifiers associated with the user identifier; and
communicating information associated with the user identifier for display to a user.

7. Logic embedded in a computer readable storage medium and operable, when executed by a processor, to:
receive a request to link a plurality of user identifiers associated with a plurality of enterprises;
receive a first user identifier associated with a first enterprise;
receive a second user identifier associated with a second enterprise;
store the first user identifier and a first enterprise identifier;
store the second user identifier and a second enterprise identifier;
determine a first account identifier associated with the first user identifier;
determine a second account identifier associated with the second user identifier; and
store the first user identifier, the second user identifier, the first account identifier, and the second account identifier in a virtual profile to link the first and second user identifiers and facilitate retrieval of information associated with the first and the second user identifiers from a selected one of the first enterprise and the second enterprise.

8. The logic of claim 7, further operable to create a data structure to store a user identifier and an enterprise identifier, wherein the data structure represents an association between the user identifier and the enterprise identifier.

9. The logic of claim 7, wherein the request comprises the first user identifier and the second user identifier.

10. The logic of claim 7, further operable to create the virtual profile by consolidating the first user identifier, the second user identifier, the first account identifier, and the second account identifier.

11. The logic of claim 7, wherein:
a third user identifier is associated with the first enterprise and the second enterprise; and
the request comprises the third user identifier.

12. The logic of claim 7, further operable to:
receive a user identifier, wherein the user identifier is a selected one of the first user identifier and the second user identifier;
access the virtual profile to determine account identifiers associated with the user identifier; and
communicate information associated with the user identifier for display to a user.

13. A system for linking user identifiers associated with first and second enterprises, comprising:
a federation module operable to link the user identifiers and the federation module comprises:
a network interface operable to:
receive a request to link a plurality of user identifiers associated with a plurality of enterprises;
receive a first user identifier associated with a first enterprise;
receive a second user identifier associated with a second enterprise;
a memory operable to:
store the first user identifier and a first enterprise identifier in a first data structure;
store the second user identifier and a second enterprise identifier in a second data structure; and
a processor communicatively coupled to the network interface and the memory and operable to:
determine a first account identifier associated with the first user identifier; and
determine a second account identifier associated with the second user identifier, wherein a virtual profile is operable to store the first user identifier, the second user identifier, the first account identifier, and the second account identifier to link the first and second user identifiers and facilitate retrieval of information associated with the first and the second user identifiers from a selected one of the first enterprise and the second enterprise.

14. The system of claim 13, wherein the processor is further operable to create a data structure to store a user identifier and an enterprise identifier, wherein the data structure represents an association between the user identifier and the enterprise identifier.

15. The system of claim 13, wherein the request comprises the first user identifier and the second user identifier.

16. The system of claim 13, wherein the processor is further operable to create the virtual profile by consolidating the first user identifier, the second user identifier, the first account identifier, and the second account identifier

17. The system of claim 13, wherein:
a third user identifier is associated with the first enterprise and the second enterprise; and
the request comprises the third user identifier.

18. The system of claim 13, wherein:
the network interface is further operable to receive a user identifier, wherein the user identifier is a selected one of the first user identifier and the second user identifier; and
the processor is further operable to access the virtual profile to determine the account identifier associated with the user identifier, wherein the network interface is further operable to communicate information associated with the user identifier for display to a user.
